(19) United States
(12) Patent Application Publication
(10) Pub. No.: US 2024/0259649 A1
(43) Pub. Date: Aug. 1, 2024

(54) VIDEO STREAM ANALYTICS

(71) Applicant: WOWZA MEDIA SYSTEMS LLC, Lakewood, CO (US)

(72) Inventors: Scott Kellicker, Worthington, OH (US); Alex Titze, Berlin (DE); James S. Sherry, Broomfield, CO (US); Ian Zenoni, Highlands Ranch, CO (US)

(21) Appl. No.: 18/631,816

(22) Filed: Apr. 10, 2024

Related U.S. Application Data
(63) Continuation of application No. 17/019,113, filed on Sep. 11, 2020.
(60) Provisional application No. 62/900,242, filed on Sep. 13, 2019.

(51) Int. Cl. H04N 21/647; H04N 21/2187; H04N 21/24; H04N 21/442

(52) U.S. Cl. CPC H04N 21/64738; H04N 21/2187; H04N 21/2407; H04N 21/442

(57) ABSTRACT

A method includes receiving analytics data from a first plurality of network components of a stream network. The analytics data is associated with the first plurality of network components streaming first chunks of a first live stream. The method also includes determining a network parameter based on the analytics data. The network parameter includes one or more live stream parameters, a distribution plan, or a combination thereof. The method further includes reconfiguring, based on the network parameter, at least a first network component of the first plurality of network components. Second chunks of the first live stream are streamed by a second plurality of network components subsequent to the reconfiguring of the first network component.

### CROSS REFERENCE TO RELATED APPLICATIONS

The present application is a continuation of U.S. Patent Application Ser. No. 17/019,113, filed on Sep. 11, 2020, currently pending, which claims priority to U.S. Provisional Patent Application Ser. No. 62/900,242, filed Sep. 13, 2019. Each of the applications listed above is expressly incorporated herein by reference in their entirety.

### BACKGROUND

The popularity of the Internet, coupled with the ever-increasing capabilities of personal/mobile electronic devices, has provided users with the ability to enjoy, as well as to generate for others to enjoy, multimedia content almost anytime and anywhere. For example, users may receive streams corresponding to live and video on demand (VOD) content (e.g., television shows and movies) at personal electronic devices, such as computers, mobile phones, and tablet computers. Further, users may use a personal electronic device to capture and stream live events (e.g., sports events) to other users.

In some cases, quality of live and/or VOD streams may vary. For example, unfavorable network conditions may result in an unpleasant viewing condition (e.g., loss of color, loss of definition, stuttering, choppiness, pauses, distortions, etc.). In some cases, there may be multiple available network paths for streaming content to a viewer. Some of the available network paths may provide improved viewing conditions for the viewers. In some cases, various network parameters can be adjusted to improve viewing conditions. However, identifying favorable network paths or network parameters in response to a viewer reported problem with the quality of a live stream and then switching to the favorable network paths or network parameters takes time, during which the viewer may get frustrated or lose interest in the live stream. Further, if the publisher the live stream is a layperson, they may not have access to information regarding available network paths, how to identify a favorable network path, how to switch to the favorable network path, which network parameters to adjust, how to adjust such network parameters, etc.

### SUMMARY

When a stream publisher is unable or elects not to test an end-to-end stream configuration before going live, unforeseen but preventable issues may crop up. In accordance with some aspects of the disclosure, prior to streaming a first live stream, the streaming of the first live stream is “tested” using a second live stream sent to a test audience. In some cases, the test audience is based on historical information associated with a source of the first live stream (e.g., a particular media device or a user associated with the first live stream). In some implementations, the test audience is based on one or more of an estimated number of viewers of the first live stream, an estimated plurality of locations of the viewers, or an estimated join rate associated with the viewers. The test audience can include actual viewer devices, virtual/simulated connections to streaming server(s), or both.

Analytics data (e.g., quality of service (QOS) data) can be collected based on the second live stream and used to initialize the first live stream. For example, by determining quality of the second live stream (as measured at computing devices of the test audience), one or more favorable network paths, one or more live stream parameters, or a combination thereof, for streaming the first live stream can be determined.

Alternatively, or in addition, during streaming of the first live stream, analytics data can be collected and used to make on-the-fly adjustments with respect to the streaming of the first live stream. For example, if a problem is identified with a particular network node along a path to a viewer, the viewer can be switched to receiving the first live stream via another path that avoids the particular network node. In some cases, the adjustments can be made proactively, prior to the viewer detecting any network issues, and can thus reduce the likelihood of the viewer experiencing unpleasant viewing conditions.

Alternatively, or in addition to using stream analytics to make on-the-fly changes to a live stream, the present disclosure enables using stream analytics after one stream has concluded to determine recommended parameters for a different stream. For example, subsequent to streaming of the first live stream, analytics data can be used to prevent (or at least reduce the likelihood of) certain network issues during streaming of content in the future. The analytics data can also be used to identify network issues, causes of the network issues, predictions regarding future network conditions, recommendations for future live streaming, automatic updates to a network configuration, etc.

According to some aspects, a visualization of the analytics data can be generated that indicates conditions that were present during the streaming of specific portions of a live stream. For example, a live stream may be recorded to a storage device and then replayed. During the replay, the streamed content can be accompanied by analytics visualizations that indicate conditions (e.g., a viewer count, a bit rate, etc.) that were present when that portion of the stream. In a particular example, a user can make inferences regarding user interest in a particular portion of the content if the viewer count drops during playback of the particular portion. In another example, the user can analyze how the network responds to changing network conditions during live streaming, such as by considering if fewer or more network resources are allocated for streaming, do more playback devices switch to a particular rendition of the live stream, etc.

### BRIEF DESCRIPTION OF THE DRAWINGS

FIG. 1 illustrates a particular implementation of a system to support live stream analytics.

FIG. 2 illustrates a particular network path of the system of FIG. 1.

FIG. 3 illustrates a second example of a system to support live stream analytics.

FIG. 4 illustrates a third example of a system to support live stream analytics.

FIG. 5 illustrates a fourth example of a system to support live stream analytics.

FIG. 6 illustrates a particular example of a graphical user interface (GUI) generated by the system of FIGS. 1 and 3-5.

FIG. 7 illustrates a particular example of a GUI generated by the system of FIGS. 1 and 3-5.

FIG. 8 illustrates a particular example of a GUI generated by the system of FIGS. 1 and 3-5.

FIG. 9 illustrates a particular example of a GUI generated by the system of FIGS. 1 and 3-5.

FIG. 10 illustrates a particular example of a GUI generated by the system of FIGS. 1 and 3-5.

FIG. 11 is a flowchart that illustrates an exemplary implementation of a method of performing live stream analytics.

### DETAILED DESCRIPTION

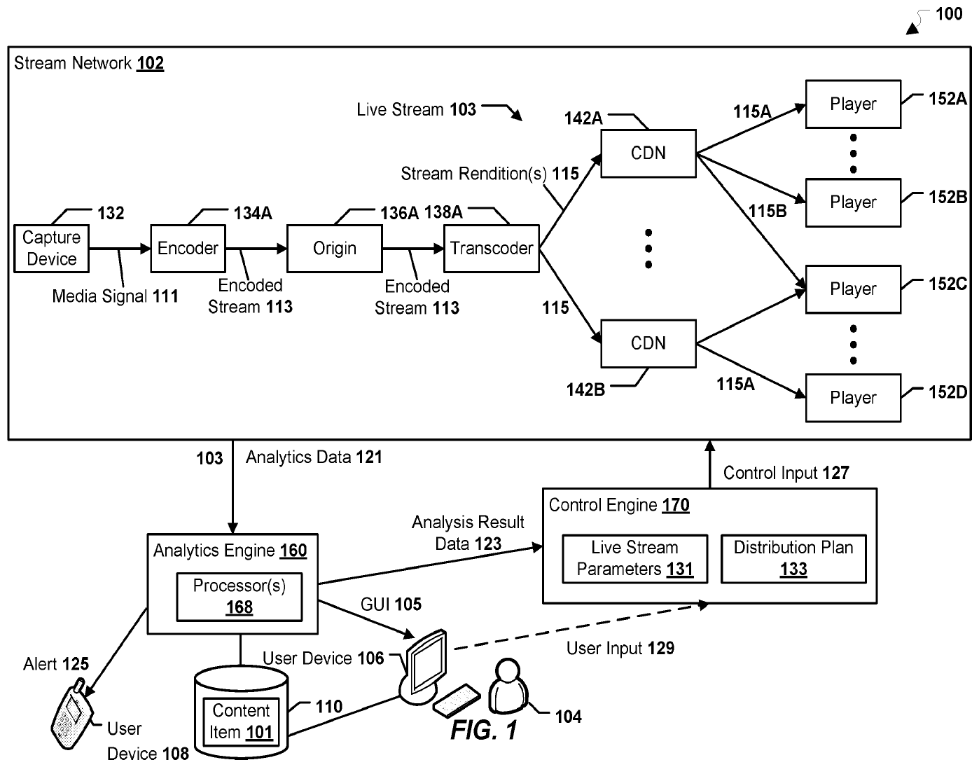

Particular implementations of systems and methods of performing live stream analytics are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple content delivery networks (CDNs) are illustrated and associated with reference numbers 142A and 142B. When referring to a particular one of these CDNs, such as the CDN 142A, the distinguishing letter “A” is used. However, when referring to any arbitrary one of these CDNs or to these CDNs as a group, the reference number 142 is used without a distinguishing letter.

Various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features, and are subsequently referred to in the singular unless aspects related to multiple of the features are being described.

FIG. 1 illustrates a particular implementation of a system 100 operable to stream content, to perform stream analytics, and to display information based on analytics data. The system 100 includes a stream network 102 that includes network components configured to live stream content. As used herein, a “stream network” (such as the stream network 102) refers to the set of network(s) and equipment involved in end-to-end communication of a stream, for example from a capture device 132 (e.g., camera) all the way to a player device 152. According to some aspects, operations described as being performed “by,” “at,” or “in” the stream network 102 may be performed by, at, or in one or more component(s) of the stream network 102. In the illustrated example, the stream network 102 includes the capture device 132, one or more encoders 134, one or more origin servers 136, one or more transcoders 138, one or more content delivery networks 142, one or more player devices 152, or a combination thereof. The capture device 132 includes one or more video cameras, one or more microphones, or a combination thereof. In the example illustrated in FIG. 1, the capture device 132 is illustrated as a single device. In other examples, the capture device 132 can include multiple devices that generate one or more media signals 111.

The stream network 102 is coupled to an analytics engine 160, a control engine 170, or both. The analytics engine 160 includes one or more processors 168. In the example of FIG. 1, the analytics engine 160 is shown as being distinct from the stream network 102. However, it is to be understood that this is not to be considered limiting. In some examples, one or more components of the analytics engine 160 may correspond to hardware and/or software components of the stream network 102. Thus, it is to be understood that at least some of the functionality described herein with reference to the analytics engine 160 may alternatively be performed by corresponding aspects of the stream network 102.

In a particular aspect, the analytics engine 160, the control engine 170, or both are coupled to one or more user devices, such as a user device 106, a user device 108, etc. In a particular aspect, the user device 106 and/or the user device 108 include a laptop computer, a mobile phone, a smartphone, a tablet computer, a media server, one or more other computing devices, or any combination thereof. The analytics engine 160, the user device 106, or both are shown as being coupled to one or more data storage devices 110.

In a particular aspect, one or more components of the stream network 102 are integrated into a laptop computer, a mobile phone, a smartphone, a tablet computer, a media server, one or more other computing devices, or any combination thereof. In some examples, an encoder 134A (e.g., a software encoder or a hardware encoder) receives a media signal 111 via input interface(s) (e.g., a high definition multimedia interface (HDMI) or a serial digital interface (SDI)) from the capture device 132. The media signal 111 corresponds to live media or previously recorded media (e.g., video on demand (VOD) and/or digital video recorder (DVR)) content. In some examples, the media signal 111 includes standard definition (SD), high definition (HD), ultra high definition (UHD), 4K, high dynamic range (HDR), 23.98/24/29.97/30/50/59.94/60 Hz frequency/frame rate, 8-bit color, and/or 10-bit color signals.

The encoder 134A is configured to encode content (e.g., audio data, video data, or both) of the media signal 111 to generate an encoded stream 113. The encoder 134A provides the encoded stream 113 via an origin server 136A to one or more transcoders 138. In some examples, the transcoders 138 are configured to generate streams in real-time (e.g., on-the-fly) or near-real-time. To illustrate, in FIG. 1, a transcoder 138A generates one or more stream renditions 115 of the encoded stream 113. In the example illustrated in FIG. 1, a single transcoder 138A is illustrated as generating the stream renditions 115. In other examples, different transcoders 138 can be used to generate multiple stream renditions 115. It is to be understood that in some examples “different” transcoders may correspond to the same transcoding algorithm but with different operating parameters.

The encoders 134 and/or transcoders 138 of the stream network 102 may be configured to perform various stream processing operations, including but not limited to one or more of bit rate conversion, CODEC conversion, frame size conversion, etc. Depending on the format of a received stream, the playback format supported by a requesting player, and/or transcoding parameters in use, a transcoding operation performed by a transcoder 138 may trigger a decoding operation by a decoder and/or a re-encoding operation by an encoder 134. In a particular aspect, parameters used by a transcoder 138 are stored in one or more transcoding templates or profiles. The stream network 102 may thus be configured to process data in accordance with multiple coding technologies and protocols.

For example, the stream network 102 may support video encoding types including, but not limited to, H.264, on2® VP-based encoding (on2 is a registered trademark of Google Inc. of Mountain View, CA), Sorenson Spark® (Sorenson Spark is a registered trademark of Sorenson Media, Inc. of Salt Lake City, UT), Screen video, Screen video 2, motion picture experts group (MPEG) 2 (MPEG-2), and MPEG-4 Part 2. The stream network 102 may support audio encoding types including, but not limited to, advanced audio coding (AAC), AAC low complexity (AAC LC), AAC high efficiency (HEAAC), G.711, MPEG Audio Layer 3 (MP3), Speex, Nellymoser Asao, and AC-3. The stream network 102 may support communication (e.g., adaptive streaming and nonadaptive streaming) protocols including, but not limited to, hypertext transfer protocol (HTTP) live streaming (HLS), HTTP dynamic streaming (HDS), smooth streaming, and MPEG dynamic adaptive streaming over HTTP (MPEG-DASH) (also known as international organization for standardization (ISO)/international electrotechnical commission (IEC) 23009-1). The stream network 102 may also support real time messaging protocol (RTMP) (and variants thereof), real-time streaming protocol (RTSP), real-time transport protocol (RTP), MPEG-2 transport stream (MPEG-TS), and WOWZ. Additional audio formats, video formats, coder/decoders (CODECs), and/or protocols may also be supported, and it is to be understood that the techniques of the present disclosure do not require any specific protocol or set of protocols for operation.

In a particular implementation, the stream network 102 (e.g., by operation of the encoder 134A and/or the transcoder 138) generates the stream renditions 115 that are adaptive bit rate (ABR) renditions that may have larger or smaller bit rates, frame sizes (also called video “resolutions”), etc. as compared to an original stream (e.g., the media signal 111). In the example illustrated in FIG. 1, the transcoder 138A provides the stream renditions 115 to a publishing destination, such as one or more CDNs 142. In some examples, the stream renditions 115 can also or in the alternative be provided to another type of publishing destination, such as a social network. In the case of publishing to a social network, the stream renditions 115 may be communicated via a social application programming interface (API). For example, use of the social API may enable one or more of the stream renditions 115 to be inserted into a message, post, or newsfeed of a particular social networking account (which may correspond to a business entity or an individual). In some aspects, the stream renditions 115 are provided to one or more player devices 152. In a particular aspect, the stream network 102 may also transmit the stream renditions 115 to the analytics engine 160. Thus, the stream network 102 may be configured to encode and/or transcode multimedia content using various techniques, such as adaptive techniques. In a particular example, the stream network 102 uses one or more live stream parameters 131, a distribution plan 133, or a combination thereof to capture, process, and/or deliver a live stream. Different sets of live stream parameters 131 and/or distribution plans 133 may be used for different live streams. The distribution plan 133 may indicate network path(s) to be used to for streaming to various destinations.

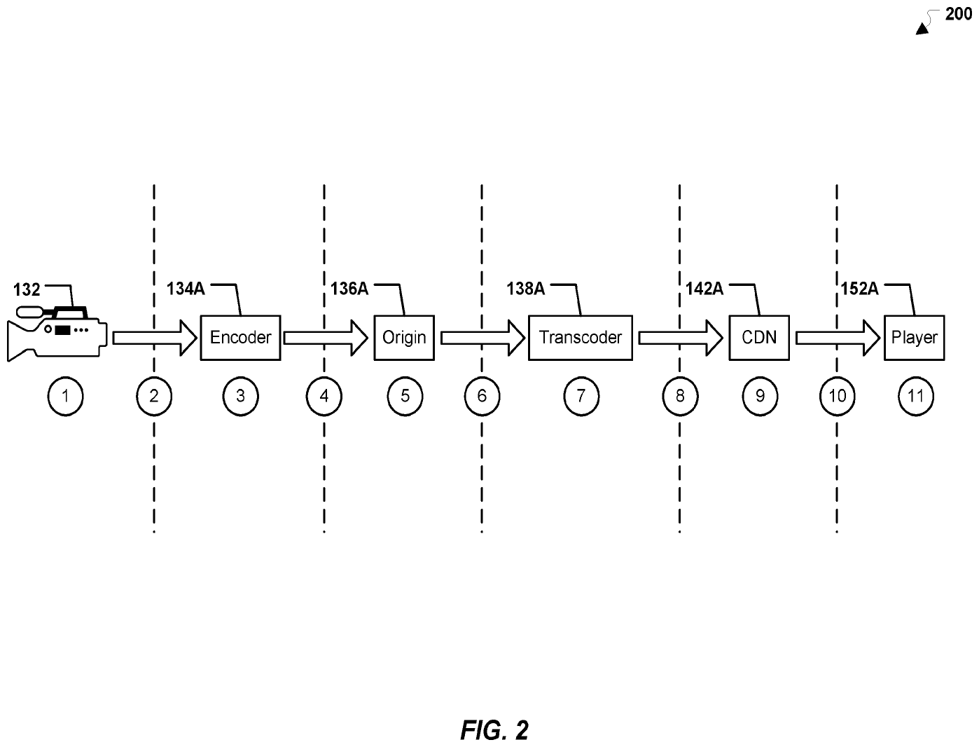

To illustrate, referring to FIG. 2, an example of a network path from the capture device 132 to a player device 152A is shown and generally designated 200. Live stream parameters 131 associated with the network path 200 may include parameters related to operation (designated “1”) at the capture device 132, communication (designated “2”) of the media signal 111 (e.g., one or more captured signals or streams) to an encoder 134A, operation (designated “3”) at the encoder 134A, communication (designated “4”) of the encoded stream 113 to an origin server 136A, operation (designated “5”) at the origin server 136A, communication (designated “6”) of the encoded stream 113 to a transcoder 138A, operation (designated “7”) at the transcoder 138A, communication (designated “8”) of the stream renditions 115 to a CDN 142A, operation (designated “9”) at the CDN 142A, communication (designated “10”) of the stream renditions 115 to a player device 152A, and/or operation (designated “11”)at the player device 152A. It is to be understood that in alternative examples, the network path between the capture device 132 and the player device 152A may include more, fewer, and/or different entities.

To further illustrate, parameters related to operation at the capture device 132 may include a frame rate, a bit rate, a frame size, network configuration/conditions, device hardware/software characteristics, etc. Parameters related to operation of the encoder 134A may include a frame rate, a bit rate, a frame size, an encoding algorithm, an encoder type, network configuration/conditions, encoder workload characteristics, device hardware/software characteristics, etc. Parameters related to operation of the origin server 136A may include a network configuration/conditions, server workload characteristics, connection information, server hardware/software characteristics, etc. Parameters related to operation of the transcoder 138A may include a frame rate, a bit rate, a frame size, transcoding algorithm(s), transcoder type(s), transcoder profile(s), number and particulars of ABR renditions to be generated, network configuration/conditions, server workload characteristics, connection information, device hardware/software characteristics, etc. Parameters related to operation of the CDN 142A may include network configuration/conditions, workload characteristics, connection information, server hardware/software characteristics, etc. Parameters related to operation at the player device 152A may include buffer size, threshold conditions at which to switch to a higher or lower ABR rendition, decoding algorithm(s), decoder type(s), number and type of network connection(s) in use to receive a stream, network configuration/conditions, device workload characteristics, connection information, device hardware/software characteristics, etc. Parameters related to communication between the various devices/processes shown in FIG. 2 may include the communication protocol in use, characteristics of wired and/or wireless connection(s) in use (e.g., dropped packets, signal strength indicators, etc.), presence and particulars of intermediate devices or networks (e.g., a CDN, the Internet, a cloud delivery infrastructure), etc.

Returning to FIG. 1, the data storage device 110 (e.g., solid-state drive (SSD) devices, magnetic storage, optical storage, etc.) may be used to store streamed events, such as a content item 101. In some examples, the data storage device 110 may also buffer chunks of the stream renditions 115 and store software programs and/or data used by the stream network 102. The data storage device 110 may include one or more computer-readable storage devices, such as random-access memory (RAM) devices, read-only memory (ROM) devices, hard-drive(s), solid state drive(s), one or more other types of storage devices, or any combination thereof. The data storage device 110 may store instructions executable by the processor 168 to perform, initiate, or control one or more operations described herein.

The analytics engine 160 is configured to process analytics data 121 generated by the stream network 102 to generate analysis result data 123, an alert 125, a graphical user interface (GUI) 105, or a combination thereof, as further described herein. One or more of the player devices 152 may receive live streams (e.g., the stream renditions 115). For example, the player devices 152 may include one or more computer systems 182, such as desktop computers, laptop computers, etc. The player devices 152 may also include one or more televisions (TVs), set-top-boxes, smartphones, or tablet computers. In some examples, at least some of the player devices 152 may be simulated using virtual connections. For example, cloud-based virtual machines may be instantiated and instructed to connect to stream sources (e.g., the transcoders 138, CDN edge nodes, etc.).

During operation, a live stream 103 may be sent to one or more player devices 152, for example upon request from individual player devices and/or via network “push” operations, such as to CDN edge nodes. In a particular example, the capture device 132 provides a media signal 111 that is encoded by the encoder 134 to generate an encoded stream 113. The encoder 134 provides the encoded stream 113 to an origin server 136A. The origin server 136A provides the encoded stream 113 to the transcoder 138A. In a particular example, the origin server 136 receives encoded streams from multiple encoders and forwards the encoded streams to various available transcoders 138. In a particular implementation, the origin server 136 performs load-balancing for the transcoders 138.

The transcoder 138A transcodes the encoded stream 113 to generate one or more of the stream renditions 115. For example, a stream rendition 115A and a stream rendition 115B are generated by transcoding the encoded stream 113 based on a first quality level (which may correspond to a particular combination of frame size, bit rate, CODECs, etc.) and a second quality level, respectively. The transcoder 138A provides the stream renditions 115 to the CDNs 142. In a particular aspect, a CDN 142A, in response to receiving a join request from a player device 152A, sends a request for the live stream 103. The transcoder 138A, responsive to determining that the CDN 142A has requested the live stream 103, provides the stream renditions 115 to the CDN 142A. In an alternative aspect, the transcoder 138A provides (e.g., pushes) the stream renditions 115 to the CDNs 142 independently of receiving requests for the live stream 103 from the CDNs 142, and each player devices that requests the live stream 103 is directed to a particular CDN (or server thereof) based on geography, load balancing, etc.

A player device 152A may send a join request to a CDN 142A to join the live stream 103. In a particular aspect, the join request indicates a stream rendition 115A (e.g., the first resolution corresponding to the stream rendition 115A). The CDN 142A, in response to receiving the stream renditions 115 from the transcoder 138A and receiving the join request from the player device 152A indicating the stream rendition 115A, provides the stream rendition 115A to the player device 152A. For example, the CDN 142 provides chunks of the stream rendition 115A to the player device 152A until the player device 152A leaves the live stream 103 or switches to another stream rendition (where the set of available may be defined in a manifest file that was previously provided to the player device 152A). In a particular aspect, the same CDN 142A provides different stream renditions to different player devices 152. For example, the CDN 142A provides chunks of the stream rendition 115A to the player device 152A concurrently with providing chunks of the stream rendition 115B to the player device 152C. In a particular aspect, multiple CDNs 142 provide the same stream rendition to different player devices 152. For example, the CDN 142A provides the stream rendition 115A to the player device 152A concurrently with the CDN 142B providing the stream rendition 115A to the player device 152D.

In a particular aspect, the live stream 103 refers to the media signal 111 communicated from the capture device 132 to the encoder 134A, the encoded stream 113 communicated from the encoder 134A to the origin server 136A, the encoded stream 113 communicated from the origin server 136A to the transcoder 138A, each of the stream renditions 115 communicated from the transcoder 138A to each of the CDNs 142, each of stream renditions 115 communicated from each of the CDNs 142 to each of the player devices 152, or a combination thereof. Communication of the live stream 103 may use one of a plurality of streaming protocols to provide the stream to the player devices 152, including but not limited to real-time transport protocol (RTP), real-time transport protocol (RTP) control protocol (RTCP), real-time messaging protocol (RTMP) over transmission control protocol (TCP), real-time streaming protocol (RTSP), etc.

In a particular aspect, the live stream 103 is communicated based on one or more live stream parameters 131, the distribution plan 133, or a combination thereof. For example, the live stream parameters 131 include encoding parameters, transcoding parameters, network communication parameters, expected audience characteristics, etc. As another example, the distribution plan 133 indicates selection criteria for selecting particular network nodes for streaming, such as a preference for particular geographic areas, particular CDNs, particular transcoders, particular origin servers, particular encoders, or a combination thereof. In a particular aspect, the live stream parameters 131, the distribution plan 133, or a combination thereof include default data, configuration data, user input, or a combination thereof.

In a particular example, the analytics engine 160 receives analytics data 121 from the stream network 102. To illustrate, the analytics data 121 includes streaming performance and/or stream quality data, such as quality of service (QOS) data. In some examples, the QoS data indicates quality of the live stream 103 as received by an audience (e.g., one or more of the player devices 152). To illustrate, in some examples, the player devices 152 of the audience provide QOS data indicating latency or error rate of the live stream 103 caused by congestion of one or more segments of the stream network 102, as an illustrative example. In some examples, each player device 152 of the audience executes a player application, and the player application prompts viewers of the live stream 103 to “vote” on quality of the live stream 103 to generate the QoS data. In other examples, QoS data is automatically generated at the player applications based on buffer occupancy over time and whether underflow or overflow conditions occur, ABR transitions, stream latency, stream jitter, how long it takes to receive stream chunks after a request is made, dropped frames/packets, etc.

To further illustrate, in some examples, the QoS data includes an indication of available network bandwidth based on a signal strength of the stream network 102 (or portion/path thereof), for example as measured by a particular player device 152 of the audience. The signal strength measurement can be a decibel (dB) measurement corresponding to a signal-to-noise ratio (SNR), a peak SNR (PSNR), a signal-to-interference-plus-noise ratio (SINR), etc. Alternatively, or in addition, when TCP is used to transmit the live stream 103, a particular computing device of the audience may detect a change in available network bandwidth of the stream network 102 based on TCP packet loss. In an additional example, RTP is used to transmit the live stream 103, and RTCP is used in conjunction to determine the QoS data. In this case, a change in available network bandwidth is indicated by a receiver report associated with a player device 152 of the audience.

In some examples, the analytics data 121 includes streaming performance data generated by the CDNs 142. For example, the CDN 142A generates streaming performance data associated with the live stream 103 indicating a cache hit rate, a count of renditions (e.g., 2 renditions) served, a count of datacenters used to serve the live stream 103, a count of bytes served, a count of viewers (e.g., player devices 152) served, etc.

In some examples, the analytics data 121 includes streaming performance data generated by the transcoders 138, the origin server 136, the encoder 134A, the capture device 132, or a combination thereof. For example, the stream performance data indicates encoding protocol, transcoding protocol, an encoding time, a transcoding time, a time between receiving and forwarding the live stream 103, etc.

In some examples, the analytics data 121 includes recommendation data indicating various recommendations, e.g., as a result of analysis performed at one or more components of the stream network 102. As an illustrative example, the live stream 103 may be available via CDN 142A and CDN 142B to a player device 152A, and the player device 152A may generate QoS data associated with receiving the stream rendition 115B from the CDN 142A. The player device 152A, in response to determining that the QoS data fails to satisfy a QoS criterion, generates recommendation data indicating a recommendation that the player device 152A switch to the CDN 142B to receive the stream rendition 115B.

It should be noted that the mechanisms described herein to generate the analytics data 121 are for illustration only, and not to be considered limiting. In alternate implementations, different mechanisms may be used to generate the analytics data 121.

The analytics engine 160 receives the live stream 103, the analytics data 121, or a combination thereof. For example, the analytics engine 160 receives the media signal 111, the encoded stream 113, one or more of the stream renditions 115, or a combination thereof. In some examples, the analytics engine 160 receives the live stream 103 and the analytics data 121 in real-time or near-real time. To illustrate, the analytics engine 160 receives chunks of the live stream 103 and receives portions of the analytics data 121 from various components of the stream network 102. Each portion of the analytics data 121 indicates a corresponding chunk of the live stream 103.

In a particular aspect, the analytics engine 160 generates a GUI 105 based on the analytics data 121 and the live stream 103, and provides the GUI 105 to the user device 106. The GUI 105 includes a visualization of the analytics data 121 that indicates network conditions during streaming various portions of the live stream 103. As an example, the live stream 103 corresponds to video content. In this example, the GUI 105 includes a display element to display the video content as received by the analytics engine 160. The GUI 105 also includes one or more data elements that display network information based on the analytics data 121. In a particular example, the analytics engine 160 updates the GUI 105 during streaming of the live stream 103. In another example, the analytics engine 160 generates the GUI 105 subsequent after the live stream 103 has concluded.

In a particular aspect, the GUI 105 indicates real-time or near-real time network conditions corresponding to streaming of the live stream 103 based on correlating timestamps in the analytics data 121 to timestamps related to the live stream 103. To illustrate, in the case where the GUI 105 is a real-time analysis dashboard, the GUI 105 displays (or outputs) a particular portion of the content of the live stream 103 in conjunction with network conditions (or other analytics data) currently associated with live streaming the particular portion. In the case where the GUI is a post-streaming analysis dashboard, the GUI 105 displays (or outputs) a particular portion of the content of the live stream 103, as it was recorded, in conjunction with network conditions (or other analytics data) that were present when the particular portion was previously streamed. In a particular example, the user 104 can use a rewind option or a forward option to move to different portions of the video content of the live stream 103 (e.g., that are being or have already been live-streamed) to view corresponding network conditions that were detected during streaming the particular portions.

As an illustrative example, if the GUI 105 shows that a count of viewers changed significantly after streaming a particular portion of the live stream 103, a user 104 can make inferences about user interest in the particular portion. To illustrate, a significant increase in viewership can indicate increased user interest and a significant decrease in viewership can indicate a loss of user interest caused by the particular portion. In some aspects, the user 104 can make decisions regarding future programming based on user interest. As another example, the GUI 105 can show how the stream network 102 responds to changes in network conditions. For example, if the GUI 105 indicates increasing network issues with a higher viewer count, the user 104 can determine that there are scalability issues to be addressed. In a particular aspect, one or more network nodes of the stream network 102 are iteratively reconfigured during live streaming. In this aspect, the GUI 105 can indicate the reconfiguration of the stream network 102 responsive to changing network conditions and indicate changes in network conditions responsive to reconfiguration of the stream network 102. For example, the GUI 105 can indicate whether fewer or more network resources were allocated, whether the player devices 152 switched to a particular stream rendition 115, whether the player devices 152 switched to a particular CDN 142, whether a particular network node was identified as associated with a network issue, whether the particular network node was subsequently avoided during streaming, whether avoiding the particular network node improved network conditions, etc.

In a particular aspect, the analytics engine 160 generates analysis result data 123 based on the analytics data 121. In an example, the analysis result data 123 includes the analytics data 121, identification of network issues, identification of network nodes of the stream network 102 associated with the identified network issues, recommendations to address the network issues, or a combination thereof. In a particular example, the analytics engine 160 identifies a particular network issue in response to determining that the analytics data 121 fails to satisfy a criterion. To illustrate, the analytics engine 160 identifies a slow network connection in response to determining that stream latency indicated by the analytics data 121 fails to satisfy a latency criterion. In a particular implementation, the particular network issue and the corresponding network criterion are based on configuration data, default data, user input, or a combination thereof.

In a particular aspect, the analytics engine 160 identifies a network node as associated with a network issue in response to determining that network nodes downstream of (e.g., receiving the live stream 103 from) the network node are having similar network issues and that network nodes downstream of other corresponding network nodes are not having similar network issues. For example, the analytics engine 160, in response to determining that each player device 152 receiving the live stream 103 via the CDN 142A is experiencing stream latencies that fail to satisfy the latency criterion and that most of the player devices 152 receiving the live stream 103 via the CDN 142B are experiencing stream latencies that satisfy the latency criterion, identifies the CDN 142A as a network node that is likely associated with the slow network connection. Alternatively, if both the CDN 142A and another CDN have connected player devices 152 experiencing issues, a component upstream of both CDNs may be investigated.

In a particular aspect, the analytics engine 160 generates a recommendation to address (e.g., reduce or resolve) a network issue. For example, the analytics engine 160, in response to determining that player devices 152 downstream from the CDN 142A are experiencing a network issue and that player devices 152 downstream from the CDN 142B are not experiencing the network issue, generates a recommendation that player devices 152 that are receiving the live stream 103 from the CDN 142A and are within a coverage area of the CDN 142B switch to receiving the live stream 103 from the CDN 142B. As another example, the analytics engine 160, in response to determining that the CDN 142A has been identified as a network node associated with a slow network connection or other issue, generates a recommendation that additional workload capacity at CDN 142A be allocated to providing the live stream 103 to player devices 152. In a particular aspect, the GUI 105 includes the analysis result data 123. In a particular aspect, the analytics engine 160 provides the analysis result data 123 to the control engine 170.

In a particular aspect, the analytics engine 160 generates an alert 125 in response to determining that an issue is indicated by the analytics data 121. For example, the alert 125 indicates the detected issue, at least a portion of the analytics data 121, at least a portion of the analysis result data 123, or a combination thereof. In a particular aspect, the GUI 105 includes the alert 125. In a particular aspect, the analytics engine 160 provides the alert 125 to one or more user devices, such as the user device 106, the user device 108, or both.

In a particular aspect, the control engine 170 generates a control input 127 based on the analysis result data 123, user input 129, or both. In a particular implementation, the control engine 170, in response to receiving the analysis result data 123, automatically generates the control input 127 corresponding to recommendations indicated in the analysis result data 123. For example, the control engine 170 generates the control input 127 based on determining that the control engine 170 has prior user approval to implement recommendations indicated the analysis result data 123. In another implementation, the control engine 170 generates the control input 127 in response to receiving user input 129 indicating user approval of an action. The action can include a recommendation (e.g., the first recommendation, the second recommendation, or both) indicated by the analysis result data 123, another action, or both. In this example, the control input 127 initiated the action indicated by the user input 129.

In a particular aspect, the control engine 170 updates the live stream parameters 131, the distribution plan 133, or both, based on the analysis result data 123, the user input 129, or both. The control engine 170 generates the control input 127 based on the updated version of the live stream parameters 131, the updated version of the distribution plan 133, or both. For example, the live stream parameters 131 indicates an updated count of servers (or other resources) of the CDN 142A to be used for streaming. As another example, the distribution plan 133 indicates a reduced preference for the CDN 142A, an increased preference for the CDN 142B, or both. To illustrate, the control input 127 indicates that content is to be streamed to the player device 152C via the CDN 142B (and not via the CDN 142A).

It should be understood that a count of servers (or other resources) and a preference for the CDN 142B are provided as illustrative examples. In other examples, the control engine 170 can make various updates to the live stream parameters 131, the distribution plan 133, or both. For example, the frame rate, the frame size, one or more bit rate(s) of one or more ABR renditions, a transcoder type or profile used to generate such ABR renditions, one or more other parameters, or a combination thereof, may be modified based on the analysis result data 123, the user input 129, or a combination thereof. As a particular illustrative example, if the analysis result data 123 indicates buffer underflow or long buffering wait times at one or more players, then the frame rate, the bit rate, and/or the frame size of one or more renditions may be reduced. Alternatively, or in addition, the distribution plan 133 may be updated to allocate more computing resources, so that high latency or error rates that are caused by congestion at CDN edges can be alleviated. As another illustrative example, if the analysis result data 123 indicates buffer underflow at one or more players, then the frame rate, the bit rate, and/or the frame size of one or more renditions may be increased (or higher quality rendition(s) may be added). Alternatively, or in addition, the distribution plan 133 may be updated to allocate fewer computing resources.

In some cases, changing the live stream parameters 131 includes changing transcoder settings or one or more transcoder profiles that will be used for streaming. In some cases, because the analytics data 121 may originate from actual/virtual audience members in various places, the analytics data 121 can be examined on a per-location or per-region basis, and the live stream parameters 131, the distribution plan 133, or both, can accordingly be adjusted on a per-location or per-region basis. To illustrate, if the analytics data 121 for North America does not indicate predicted streaming issues but the analytics data 121 for Australia indicates predicted streaming issues, video settings, audio settings, encoding/transcoding resources, and/or distribution resources may be adjusted for Australian audiences but not for North American audiences. Alternatively, some resources that were previously allocated for North American audiences may instead be allocated for Australian audiences. In some examples, the control engine 170 is configured to send an indication of the one or more live stream parameters 131, the distribution plan 133, or both, to the user device 106.

In a particular example, the control engine 170 uses the control input 127 to make changes during streaming of the live stream 103 so that subsequent chunks of the live stream 103 are streamed based on the updated live stream parameters 131, the updated distribution plan 133, or both. The control engine 170 thus enables addressing network issues that are detected during streaming of the live stream 103 while the live stream 103 is being provided to the player devices 152 to improve user experience (or to prevent an unfavorable user experience).

In a particular example, the control engine 170 uses the control input 127 to make changes prior to streaming a subsequent live stream. The control engine 170 may be configured to initiate the subsequent live stream based on the updated version of the live stream parameters 131, the updated version of the distribution plan 133, or both, which may be modified from a user's initial selections for the live stream 103, the subsequent live stream, or both. The distribution plan 133 may affect particular network paths used to distribute the subsequent live stream. As described herein and illustrated in FIG. 2, the live stream parameters 131 may affect operation of capture devices, encoders, origin servers, transcoders, CDNs, and player devices, and also affect communication of data between those components. In some examples, the live stream parameters 131 (or modifications thereto) are communicated to components via application programming interfaces (APIs).

In some examples, the analysis result data 123 generated in accordance with the present disclosure are shown to a user on a dashboard (e.g., the GUI 105) that divides the end-to-end stream generation and transport process similar to the paradigm used in FIG. 2. Places with predicted problems may be visually highlighted using different colors/flashing, and recommendations may be provided for such places. In some examples, the dashboard shows test results, problems, and/or recommended solutions for different geographic regions/locations using a map.

When problems are predicted, initially selected live stream parameters 131, distribution plan 133, or both, may be modified. Such modifications may be made manually by a user, for example based on recommendations displayed by the GUI 105. Alternatively, or in addition, modifications to the live stream parameters 131 may be made automatically. In some examples, heuristics, machine learning models, artificial intelligence techniques, etc. may be used to determine what changes to recommend based on the analysis result data 123. As an illustrative non-limiting example, heuristics, machine learning models, artificial intelligence techniques, etc. may be used to assess ABR playback and rendition settings when evaluated for different network situations (e.g., mobile vs. Wi-Fi vs. wired, etc.). As another example, heuristics, machine learning models, artificial intelligence techniques, etc. may be used to evaluate hardware encoder settings and performance, which can correspond to an ingest/first mile segment of the end-to-end live stream configuration.

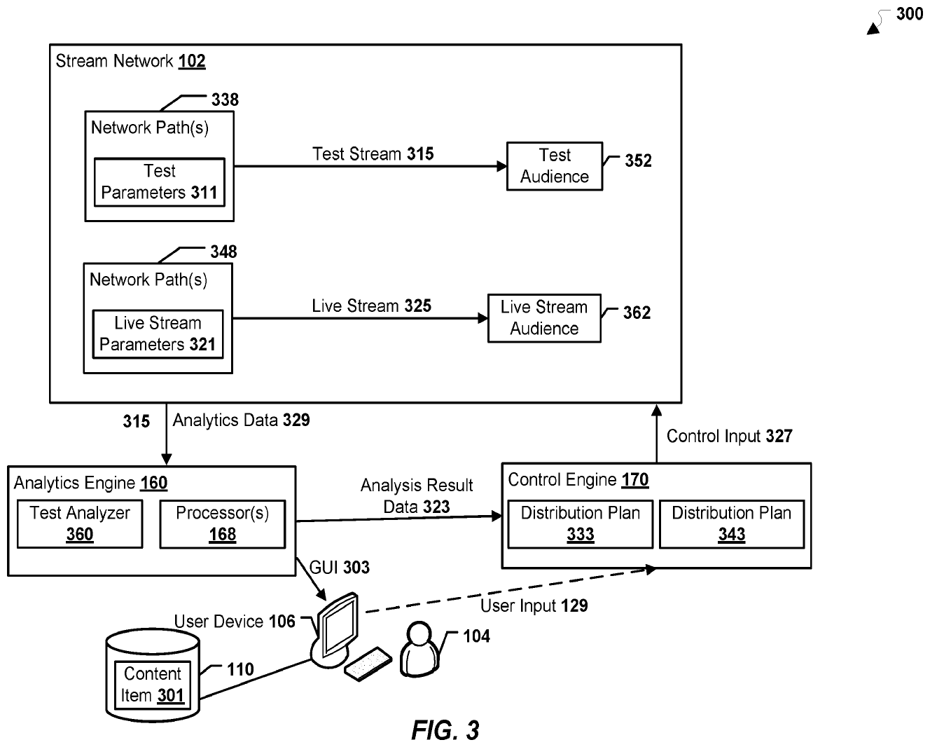

Referring to FIG. 3, a system operable to support live stream analytics is shown and generally designated 300. In a particular aspect, the system 100 of FIG. 1 includes one or more components of the system 300. The analytics engine 160 includes a test analyzer 360. The test analyzer 360 is configured to process analytics data 329 corresponding to a test stream to generate recommendations for streaming a live stream.

During operation, a user 104 uses a multimedia application to configure the stream network 102 to stream a live stream 325. In a particular aspect, the user 104 provides one or more initial live stream parameters, an initial distribution plan, or a combination thereof, for streaming the live stream 325. In a particular aspect, the user 104 specifies a live stream audience 362 that is to receive the live stream 325. For example, the user 104 provides device addresses, viewer characteristics, device characteristics, or a combination thereof, corresponding to the live stream audience 362.

In a particular aspect, the control engine 170 performs a test live stream prior to streaming the live stream 325. In a particular example, the control engine 170 performs the test live stream in response to detecting scheduling of streaming of the live stream 325. In an alternative example, the control engine 170 performs the test live stream in response to a user selection of a test option.

The control engine 170 generates test parameters 311 based on the initial live stream parameters, a set of test parameters associated with streaming another live stream, configuration data, default data, or a combination thereof. The control engine 170 generates a distribution plan 333 based on the initial distribution plan, a distribution plan associated with streaming another live stream, configuration data, default data, or a combination thereof. The control engine 170 selects a test audience 352 based on the live stream audience 362 (e.g., device addresses, viewer characteristics, device characteristics, or a combination thereof, corresponding to the live stream audience 362). The test audience 352 includes one or more of the player devices 152 of FIG. 1. For example, the test audience 352 includes a virtual player device, a physical player device, or both. In a particular aspect, the control engine 170 selects the test audience 352 that changes during streaming, e.g., to simulate player devices joining and leaving a live stream. In a particular aspect, the control engine 170 selects the test audience 352 to include player devices 152 that are not representative of the user selected audience characteristics to test for unexpected situations. For example, the user 104 may specify a first count of expected viewers for the live stream 325 and the control engine 170 may select the test audience 352 to a go up to a second viewer count (e.g., that is 10 times higher than the first count) during at least a portion of the test live stream.

The control engine 170 configures the stream network 102 based on the test parameters 311, the distribution plan 333, or a combination thereof. For example, the control engine 170 configures one or more network nodes of one or more network paths 338 based on the test parameters 311, the distribution plan 333, or a combination thereof. The control engine 170 initiates streaming of a test stream 315 via the network paths 338 to the test audience 352. It should be understood that the division of functionality between the test analyzer 360 and the control engine 170 is provided as an illustrative example. In some examples, the test analyzer 360 can perform one or more operations described herein with reference to the control engine 170, and vice versa.

In a particular aspect, media content of the test stream 315 differs from media content of the live stream 325. For example, the media content of the live stream 325 (e.g., a live concert) may not be available for testing prior to the scheduled streaming of the live stream 325. In a particular example, the media content of the test stream 315 corresponds to pre-recorded content. In a particular aspect, the pre-recorded content is stored in the data storage device 110 as a content item 301.

The analytics engine 160 receives analytics data 329, the test stream 315, or a combination thereof, from the stream network 102. In a particular aspect, the analytics data 329 and the test stream 315 correspond to the analytics data 121 and the live stream 103, respectively, of FIG. 1. In a particular aspect, the analytics engine 160 stores the received test stream 315 as a content item 301 in the data storage device 110. The test analyzer 360 generates analysis result data 323 by analyzing the analytics data 329. In a particular aspect, the test analyzer 360 processes the analytics data 329 using heuristics, machine learning models, artificial intelligence techniques, etc. to identify factors that significantly affect streaming quality and viewer experience and to determine modifications to the factors that are likely to improve the streaming quality and viewer experience. In a particular aspect, the analysis result data 323 corresponds to the analysis result data 123 of FIG. 1. For example, the analysis result data 323 indicates network issues, network nodes associated with the network issues, predictions, recommendations, or a combination thereof. To illustrate, the test analyzer 360, in response to determining that the analytics data 329 indicates that player devices 152 of the test audience 352 having a particular browser version reported issues with a first encoding version and not with a second encoding version, generates a prediction that player devices 152 of the live stream audience 362 having the particular browser version are likely to have streaming issues and generates a recommendation that the player devices 152 having the particular browser version be provided the live stream 325 corresponding to the second encoding version. In some examples, whether a suggested solution was successful or not is used as feedback/further training date for the machine learning model that was used to identify the suggested solution.

In a particular aspect, the test analyzer 360 generates a GUI 303 indicating the analysis result data 323 and provides the GUI 303 to the user device 106. For example, the GUI 303 illustrates network conditions detected during streaming of the test stream 315. In a particular aspect, the test analyzer 360 provides the analysis result data 323 to the control engine 170. In a particular aspect, the control engine 170 receives user input 129 from the user device 106. In a particular aspect, the control engine 170 generates live stream parameters 321, a distribution plan 343, or a combination thereof, based on the analysis result data 323, user input 129, or a combination thereof.

In a particular example, the test analyzer 360 and the control engine 170 perform multiple iterations of test streaming before generating the live stream parameters 321, the distribution plan 343, or a combination thereof, for the live stream 325. The control engine 170 generates control input 327 based on the live stream parameters 321, the distribution plan 343, or a combination thereof, to configure the stream network 102 for streaming the live stream 325 via one or more network paths 348 to the live stream audience 362. In a particular aspect, the test audience 352 includes at least one player device 152 that is not included in the live stream audience 362, and vice versa. In a particular aspect, the test audience 352 includes at least one player device 152 that is included in the live stream audience 362.

Using the live stream parameters 321, the distribution plan 343, or both, reduces a likelihood of network issues occurring during streaming of the live stream 325. For example, player devices 152 of the live stream audience 362 having the particular browser version are provided with the live stream 325 having the second encoding version to prevent streaming issues associated with the first encoding version. Prevention of streaming issues results in favorable viewer experience and avoids loss of viewer interest in the streamed content. Detection of possible network issues prior to live streaming also gives the user 104 additional time to make changes that take longer to implement than would be practical during a live stream For example, updates (e.g., software updates, hardware updates, or both) could be performed on network components of the stream network 102, additional resources could be purchased prior to streaming the live stream 325, etc.

Although various examples described herein may involve an analytic engine that is distinct from player devices, in certain aspects player devices themselves may be configured to perform analysis. To illustrate, certain player devices may be “prescriptive” players that have the ability to analyze the playback experience and make recommendations on how to optimize the streaming. These recommendations could affect encoder settings, how streamer servers/cloud services are configured, how network(s) should be optimized, and how the player configuration could be optimized. In some examples, such functionality may be extended to a “fleet” of prescriptive players running in various configurations that differ in terms of device hardware, devices, browsers, operating systems, regions, network connection (e.g., 3G vs Wi-Fi), etc. The prescriptive players may report such information back into a centralized data repository for further analyzed.

A perspective player may automatically detect things like bitrate, adaptive bitrate renditions, buffering that occurs, download times, adaptive bitrate rendition switches, video formats, encoding profiles, metadata, timestamp discrepancies, etc. The prescriptive player may report the detected information in a player-side console and/or transmit the information back to a data gathering server. Some information may be associated with monitoring (e.g., showing metadata events arriving at player), whereas other information may be analyzed based on playback experience (e.g., video size and bitrate too large, inefficient adaptive bitrate renditions provided causing non-optimal switching or video quality experience, codecs profiles that are not widely supported across a variety of platforms, gaps in audio and video, latency measurements, latency drift, etc.). A prescriptive player as described herein may thus be configured to make suggestions on infrastructure and streaming configuration by evaluating at playback experience.

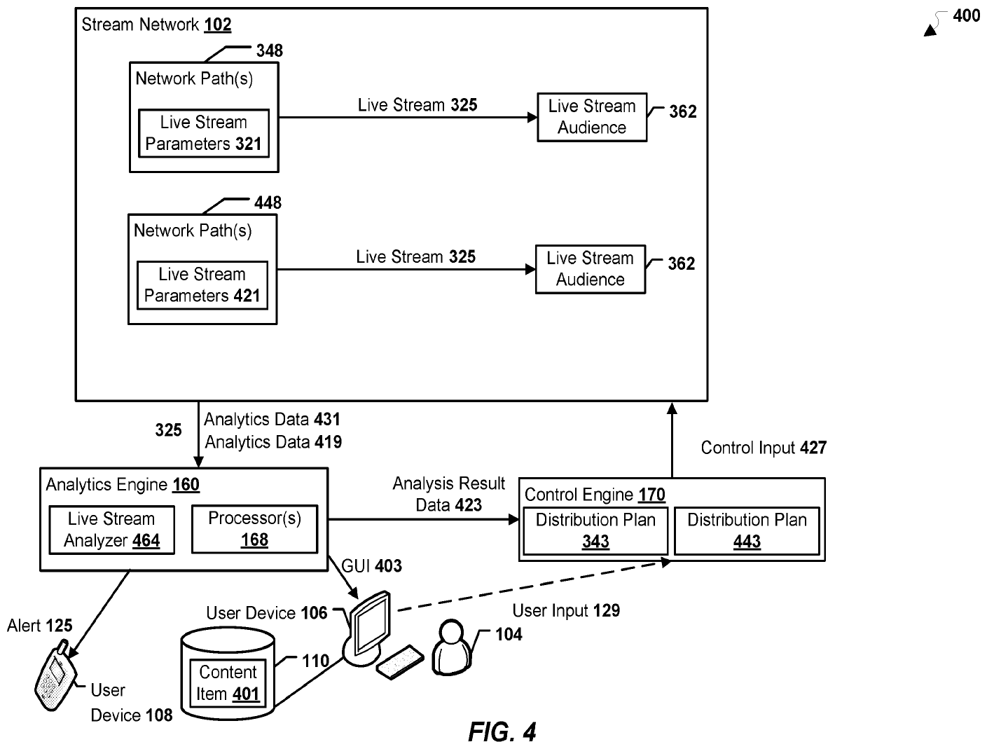

Referring to FIG. 4, a system operable to support live stream analytics is shown and generally designated 400. In a particular aspect, the system 100 of FIG. 1 includes one or more components of the system 400. The analytics engine 160 includes a live stream analyzer 464. The live stream analyzer 464 is configured to process analytics data 329 generated during streaming of a live stream to generate recommendations for making adjustments during streaming the live stream.

During operation, a user 104 uses a multimedia application to initiate streaming of the live stream 325. For example, the user 104 provides user input to the user device 106 and the user device 106 schedules streaming of the live stream 325 based on the live stream parameters 321, the distribution plan 343, or a combination thereof, as described with reference to FIG. 3.

The control engine 170 configures the stream network 102 based on the live stream parameters 321, the distribution plan 343, or a combination thereof. For example, the control engine 170 configures one or more network nodes of one or more network paths 348 based on the live stream parameters 321, the distribution plan 343, or a combination thereof. The control engine 170 initiates streaming of the live stream 325 via the network paths 348 to the live stream audience 362. It should be understood that the division of functionality between the live stream analyzer 464 and the control engine 170 is provided as an illustrative example. In some examples, the live stream analyzer 464 can perform one or more operations described herein with reference to the control engine 170, and vice versa.

The analytics engine 160 receives analytics data 419, the live stream 325, or a combination thereof, from the stream network 102. In a particular aspect, the analytics engine 160 stores the received live stream 325 as a content item 401 in the data storage device 110. For example, first chunks of the live stream 325 received by the analytics engine 160 are decoded and stored as a first portion of the content item 401. The live stream analyzer 464 generates analysis result data 423 by analyzing the analytics data 419. In a particular aspect, the live stream analyzer 464 processes the analytics data 419 using heuristics, machine learning models, artificial intelligence techniques, etc. to identify factors that significantly affect streaming quality and viewer experience and to determine modifications to the factors that are likely to improve the streaming quality and viewer experience. In a particular aspect, the analysis result data 423 corresponds to the analysis result data 123 of FIG. 1. For example, the analysis result data 423 indicates network issues, network nodes associated with the network issues, predictions, recommendations, or a combination thereof. To illustrate, the live stream analyzer 464, in response to determining that the analytics data 419 indicates that a transcoding time associated with a transcoder 138A of the network paths 348 fails to satisfy a transcoding time threshold, generates a recommendation with a reduced preference for the transcoder 138A.

In a particular aspect, the live stream analyzer 464 generates an alert 125 in response to detecting network issues and sends the alert 125 to one or more user devices, such as the user device 108. In a particular aspect, the live stream analyzer 464 generates a GUI 403 indicating the analysis result data 423 and provides the GUI 403 to the user device 106. For example, the GUI 403 illustrates network conditions detected during streaming of the live stream 325, network nodes associated with network issues, recommendations to address the network issues, or a combination thereof. In a particular aspect, the live stream analyzer 464 provides the analysis result data 423 to the control engine 170. In a particular aspect, the control engine 170 receives user input 129 from the user device 106. In a particular aspect, the control engine 170 generates live stream parameters 421, a distribution plan 443, or a combination thereof, based on the analysis result data 423, user input 129, or a combination thereof. For example, the distribution plan 443 indicates a reduced preference for the transcoder 138A.

The control engine 170 generates control input 427 based on the live stream parameters 421, the distribution plan 443, or a combination thereof, to reconfigure the stream network 102 for streaming the live stream 325 via one or more network paths 448 to the live stream audience 362. For example, the control engine 170 reconfigures the origin server 136A to have a reduced preference for the transcoder 138A. The origin server 136A, subsequent to the reconfiguration and in response to determining that a transcoder 138B associated with a higher preference is available, selects the transcoder 138B to transcode subsequent chunks of the encoded stream 113 corresponding to the live stream 325. In a particular aspect, the live stream audience 362 changes over time as player devices 152 join or leave the live stream 325.

The analytics engine 160, subsequent to reconfiguring the stream network 102, receives the live stream 325 and analytics data 431. For example, the analytics engine 160 receives second chunks of the live stream 325 streamed subsequent to reconfiguring the stream network 102 and stores the second chunks as a second portion of the content item 401. The analytics engine 160 stores the analytics data 431 as corresponding to the second chunks. In a particular aspect, the live stream analyzer 464, responsive to receiving updated analytics data, performs multiple reconfigurations of the stream network 102 during streaming of the live stream 325.

Using the live stream parameters 421, the distribution plan 443, or both, addresses network issues that are detected by the live stream analyzer 464 during streaming of the live stream 325. In some cases, the control engine 170 resolves the network issues by reconfiguring the stream network 102 prior to the network issues affecting viewer experience. For example, switching to the transcoder 138B can reduce streaming latency by reducing transcoding delays before streaming delays are noticeable by (and reported by) viewers. In other cases, the control engine 170 improves user experience by resolving network issues during streaming of a subsequent portion of the live stream 325 that were detected during streaming of a prior portion of the live stream 325. The system 400 can thus reconfigure the stream network 102 in real-time or near-real time during streaming of the live stream 325 responsive to changing network conditions.

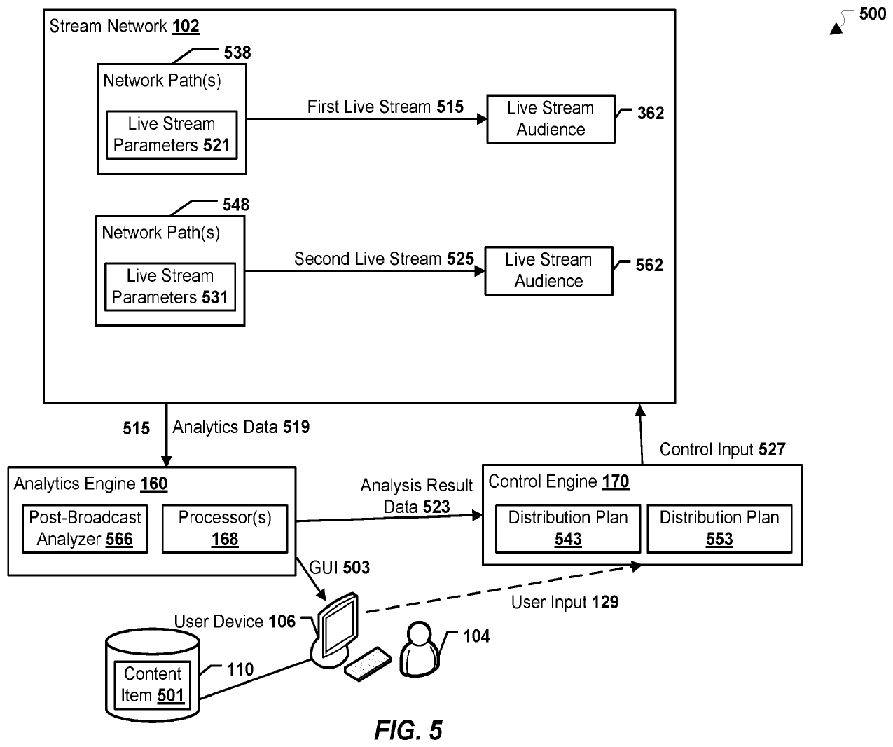

Referring to FIG. 5, a system operable to support live stream analytics is shown and generally designated 500. In a particular aspect, the system 100 of FIG. 1 includes one or more components of the system 500. The analytics engine 160 includes a post-broadcast analyzer 566. The post-broadcast analyzer 566 is configured to, subsequent to streaming of a first live stream 515, generate recommendations for streaming a second live stream 525 based on analytics data 519 generated during and/or after streaming of the first live stream 515.

During operation, the post-broadcast analyzer 566, subsequent to streaming of a first live stream 515, processes analytics data 519 generated during streaming of the first live stream 515. In a particular aspect, one or more network paths 538 used to stream the first live stream 515 are configured based on one or more live stream parameters 521, a distribution plan 543, or a combination thereof. In a particular aspect, the first live stream 515 corresponds to the live stream 325 of FIG. 3. In this aspect, the live stream parameters 521 include the live stream parameters 321 of FIG. 3, and the analytics data 519 includes the analytics data 419 associated with streaming a first portion of the live stream 325. In addition, the live stream parameters 521 include the live stream parameters 421 of FIG. 4, and the analytics data 519 includes the analytics data 431 associated with streaming a second portion of the live stream 325.

In a particular aspect, the post-broadcast analyzer 566 performs more time-intensive data processing as compared to the live stream analyzer 464. In a particular aspect, the post-broadcast analyzer 566 analyzes multiple sets of analytics data corresponding to multiple live streams.

The post-broadcast analyzer 566 generates analysis result data 523 based on the analytics data 519. In a particular aspect, the post-broadcast analyzer 566 processes the analytics data 519 using heuristics, machine learning models, artificial intelligence techniques, etc. to identify factors that affect streaming quality and viewer experience and to determine modifications to the factors that are likely to improve the streaming quality and viewer experience. In a particular aspect, the analysis result data 523 corresponds to the analysis result data 123 of FIG. 1. For example, the analysis result data 523 indicates network issues, network nodes associated with the network issues, predictions, recommendations, or a combination thereof. In a particular aspect, the analysis result data 523 generated by the post-broadcast analyzer 566 include recommendations that are more time-intensive to implement, have greater impact on the stream network 102, are conditioned on approval from higher level management, involve a higher monetary investment, or a combination thereof, as compared to recommendations indicated by the analysis result data 423 generated by the live stream analyzer 464. To illustrate, the post-broadcast analyzer 566, in response to determining that the analytics data 519 indicates that a transcoding time associated with a transcoder 138A of the network paths 348 fails to satisfy a transcoding time threshold, generates a recommendation to perform an update (e.g., a software update, a hardware update, or both) of the transcoder 138A, a recommendation to replace the transcoder 138, a recommendation to send an issue report to a system administrator of the transcoder 138A, a recommendation to reduce a preference for the transcoder 138A, or a combination thereof. The issue report can provide information (e.g., the longer than threshold transcoding latency) that assists the system administrator to identify and resolve performance problems of the transcoder 138A.

In a particular aspect, the post-broadcast analyzer 566 generates a GUI 503 indicating the analysis result data 523 and provides the GUI 503 to the user device 106. In a particular aspect, the post-broadcast analyzer 566 provides the analysis result data 523 to the control engine 170. In a particular aspect, the control engine 170 receives user input 129 from the user device 106. In a particular aspect, the control engine 170 generates live stream parameters 531, a distribution plan 553, or a combination thereof, based on the analysis result data 523, user input 129, or a combination thereof. In a particular example, the control engine 170, in response to receiving the user input 129 indicating that performance issues of the transcoder 138A have been resolved (e.g., by the system administrator), generates the distribution plan 553 indicating a neutral preference for the transcoder 138A.

The control engine 170 generates control input 527 based on the live stream parameters 531, the distribution plan 553, or a combination thereof, to reconfigure the stream network 102 for streaming a second live stream 525 via one or more network paths 548 to a live stream audience 562. For example, the control engine 170 reconfigures the origin server 136A to have a neutral preference for the transcoder 138A The origin server 136A, subsequent to the reconfiguration and in response to determining that the transcoder 138A is available, selects the transcoder 138A to transcode chunks of an encoded stream 113 corresponding to the second live stream 525. Using the live stream parameters 531, the distribution plan 553, or both, addresses network issues that are detected by the post-broadcast analyzer 566 during streaming of the first live stream 515.

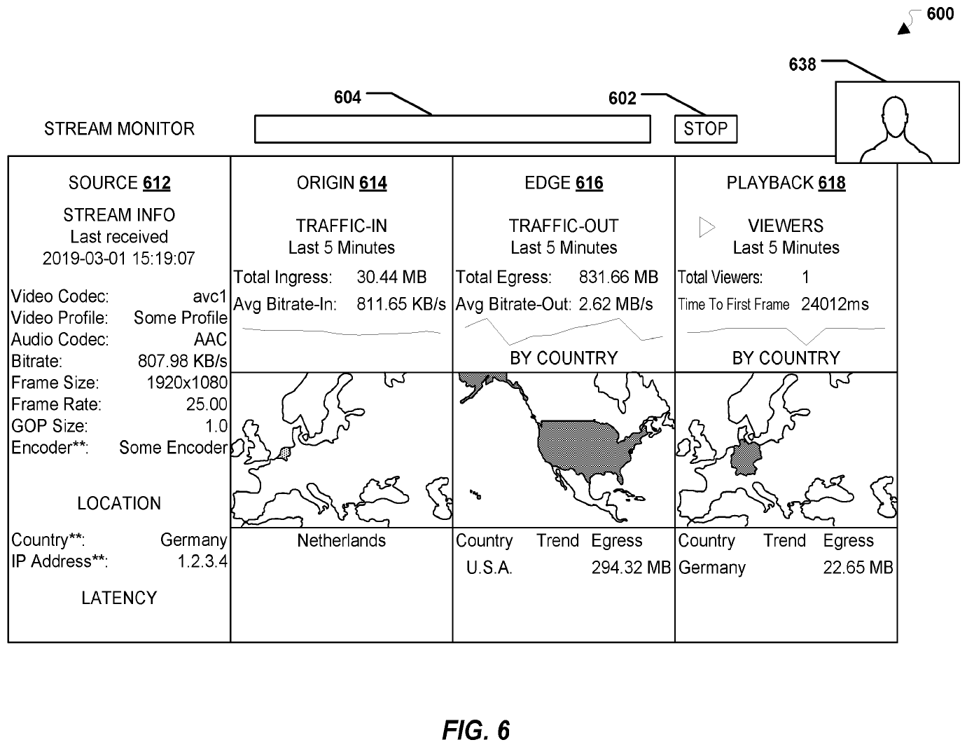

Referring to FIG. 6, an example of a GUI is shown and generally designated 600. In a particular aspect, the GUI 600 is generated by the analytics engine 160, the system 100 of FIG. 1, the test analyzer 360, the system 300 of FIG. 3, the live stream analyzer 464, the system 400 of FIG. 4, the post-broadcast analyzer 566, the system 500 of FIG. 5, or a combination thereof. In a particular aspect, the GUI 600 corresponds to the GUI 105 of FIG. 1.

The GUI 600 includes a display element 638 that is configured to display a visualization of content of the live stream 103 of FIG. 1. In a particular example, the live stream 103 includes video content and the display element 638 displays a frame of the video content. The GUI 600 includes a source column 612, an origin column 614, an edge column 616, a playback column 618, or a combination thereof. The source column 612 illustrates a portion of the analysis results data 123 of FIG. 1 that is associated with a source of the stream network 102. In a particular aspect, the source of the stream network 102 includes the encoder 134A of FIG. 1.

The origin column 614 illustrates a portion of the analysis results data 123 of FIG. 1 that is associated with an origin of the stream network 102. In a particular aspect, the origin of the stream network 102 includes the origin server 136A of FIG. 1.

The edge column 616 illustrates a portion of the analysis results data 123 of FIG. 1 that is associated with an edge of the stream network 102. In a particular aspect, the edge of the stream network 102 includes the transcoders 138, the CDNs 142 of FIG. 1, or a combination thereof.

The playback column 618 illustrates a portion of the analysis results data 123 of FIG. 1 that is associated with one or more player devices of the stream network 102. In a particular aspect, the player devices of the stream network 102 include one or more of the player devices 152 of FIG. 1.

In a particular aspect, the GUI 600 includes an option 604 (e.g., a text field) to enter an identifier (e.g., URL) for a live stream. The user device 106, in response to receiving the identifier indicated by the option 604, retrieves the analysis result data 123 corresponding to the live stream 103 associated with the identifier and updates the GUI 600 based on the analysis result data 123. In a particular aspect, a rewind option can be used to display a prior portion of the content (e.g., relative to the portion of the content being displayed by the display element 638). In a particular aspect, a forward option can be used to display a subsequent portion of the content (e.g., relative to the portion of the content being displayed by the display element 638) that has been livestreamed. The GUI 600 includes an option 602 (e.g., a pause option or a stop option) to pause the display of content by the display element 638.

The GUI 600 displays information in each of the columns 612, 614, 616, and 618 corresponding to streaming of the portion of the content (e.g., the frame) displayed in the display element 638. For example, information displayed in one or more of the columns 612, 614, 616, or 618 can change as content displayed in the display element 638 is updated. In a particular aspect, the GUI 600 displays information by geographic region (e.g., by country). The GUI 600 thus enables a user to view the analysis results data 123 corresponding to streaming of a displayed portion of content. In a particular example, the user can use the GUI 600 to view the analysis results data 123 corresponding to a live stream during streaming of the live stream In another example, the user can use the GUI 600 to view the analysis results data 123 corresponding to a live stream subsequent to an end of streaming of the live stream.

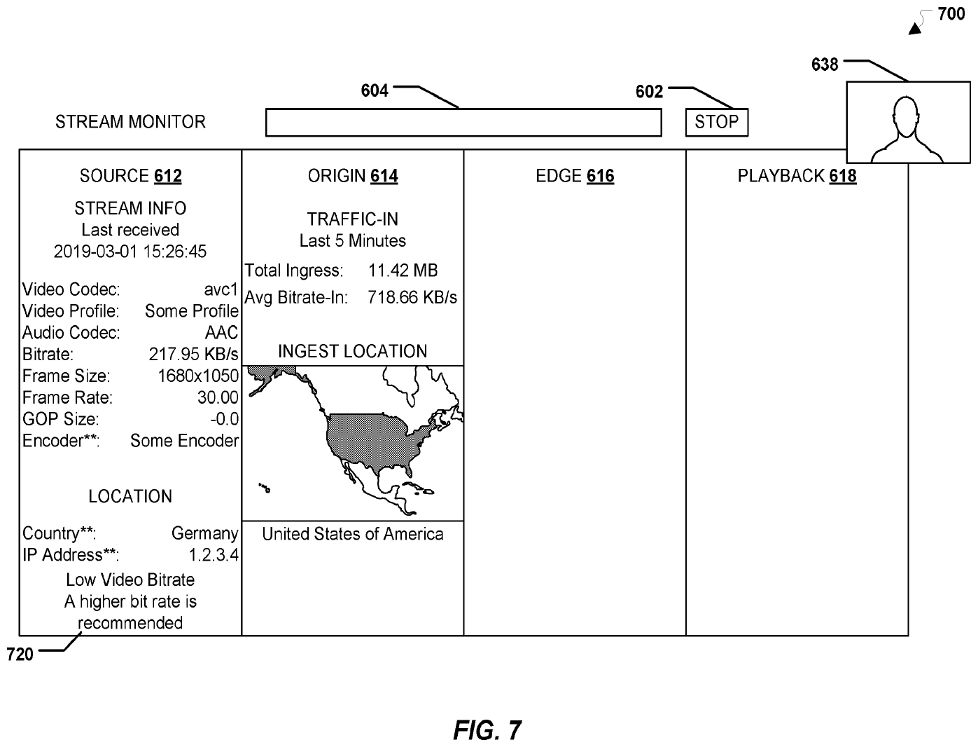

Referring to FIG. 7, an example of a GUI is shown and generally designated 700. In a particular aspect, the GUI 700 is generated by the analytics engine 160, the system 100 of FIG. 1, the test analyzer 360, the system 300 of FIG. 3, the live stream analyzer 464, the system 400 of FIG. 4, the post-broadcast analyzer 566, the system 500 of FIG. 5, or a combination thereof. In a particular aspect, the GUI 700 corresponds to the GUI 105 of FIG. 1.

The GUI 700 includes an alert 720. The alert 720 identifies a network issue (e.g., a low bitrate) that has been detected while streaming the live stream 103. The alert 720 also includes a recommendation (e.g., a higher bitrate is recommended). In the example illustrated in FIG. 7, the empty edge column 616 and the empty playback column 618 indicate that the live stream 103 has not been forwarded from the origin servers 136 to the CDNs 142 of FIG. 1. In a particular aspect, the analytics engine 160 can generate the analysis result data 123 indicating that a higher bitrate is recommended. The GUI 700 thus enables a user to view identified network issues and recommendations associated with streaming a live stream.

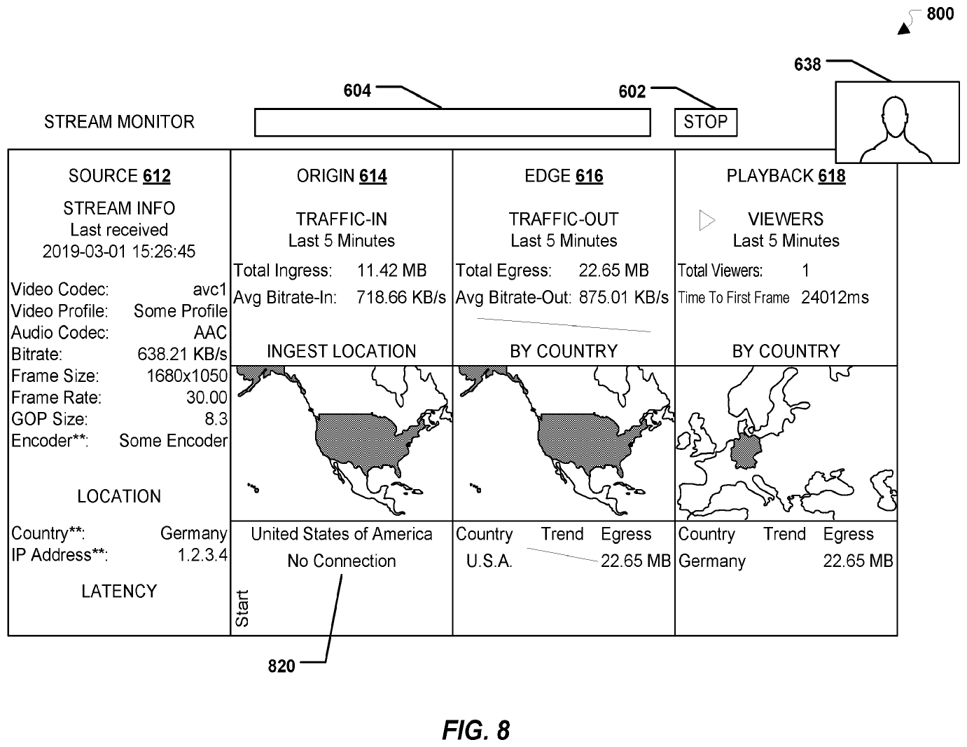

Referring to FIG. 8, an example of a GUI is shown and generally designated 800. In a particular aspect, the GUI 800 is generated by the analytics engine 160, the system 100 of FIG. 1, the test analyzer 360, the system 300 of FIG. 3, the live stream analyzer 464, the system 400 of FIG. 4, the post-broadcast analyzer 566, the system 500 of FIG. 5, or a combination thereof. In a particular aspect, the GUI 800 corresponds to the GUI 105 of FIG. 1.

The GUI 800 includes an alert 820 indicating that the live stream 103 has not been received by the origin server 136A. The GUI 800 thus enables a user to view identified network issues associated with streaming a live stream.

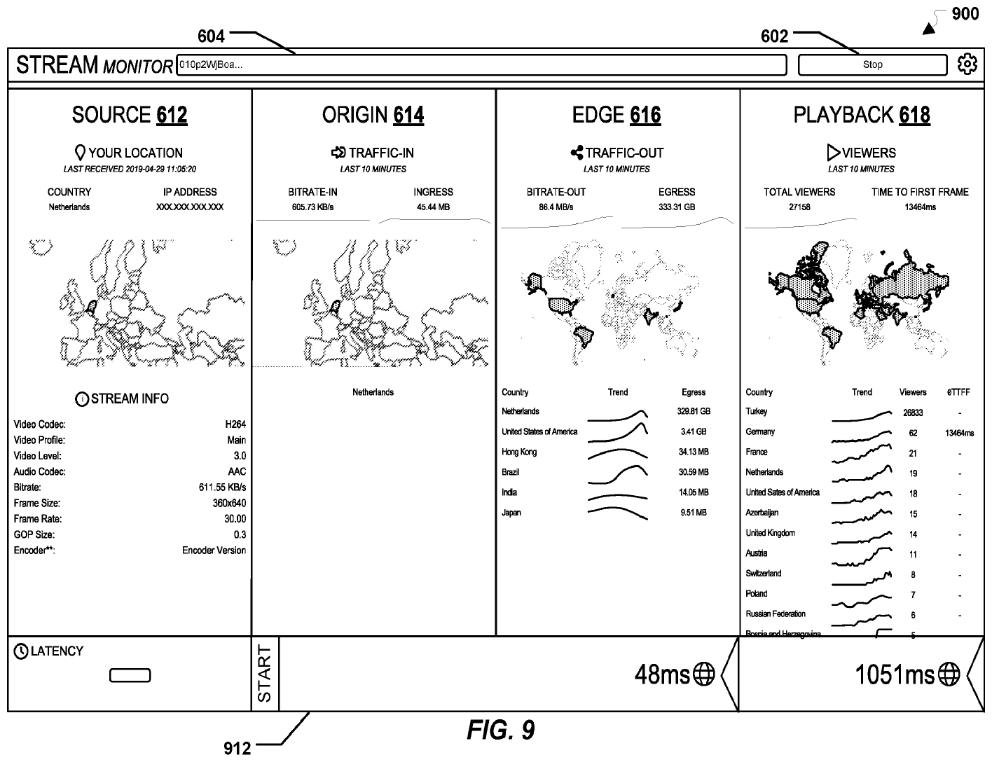

Referring to FIG. 9, an example of a GUI is shown and generally designated 900. In a particular aspect, the GUI 900 is generated by the analytics engine 160, the system 100 of FIG. 1, the test analyzer 360, the system 300 of FIG. 3, the live stream analyzer 464, the system 400 of FIG. 4, the post-broadcast analyzer 566, the system 500 of FIG. 5, or a combination thereof. In a particular aspect, the GUI 900 corresponds to the GUI 105 of FIG. 1.

The GUI 900 includes an element 912 that includes a portion of the analysis result data 123 corresponding to multiple components of the stream network 102. For example, the element 912 indicates a latency associated with receiving a frame of the live stream 103 at the origin server 136A and transmitting the frame of the live stream 103 from a CDN 142.

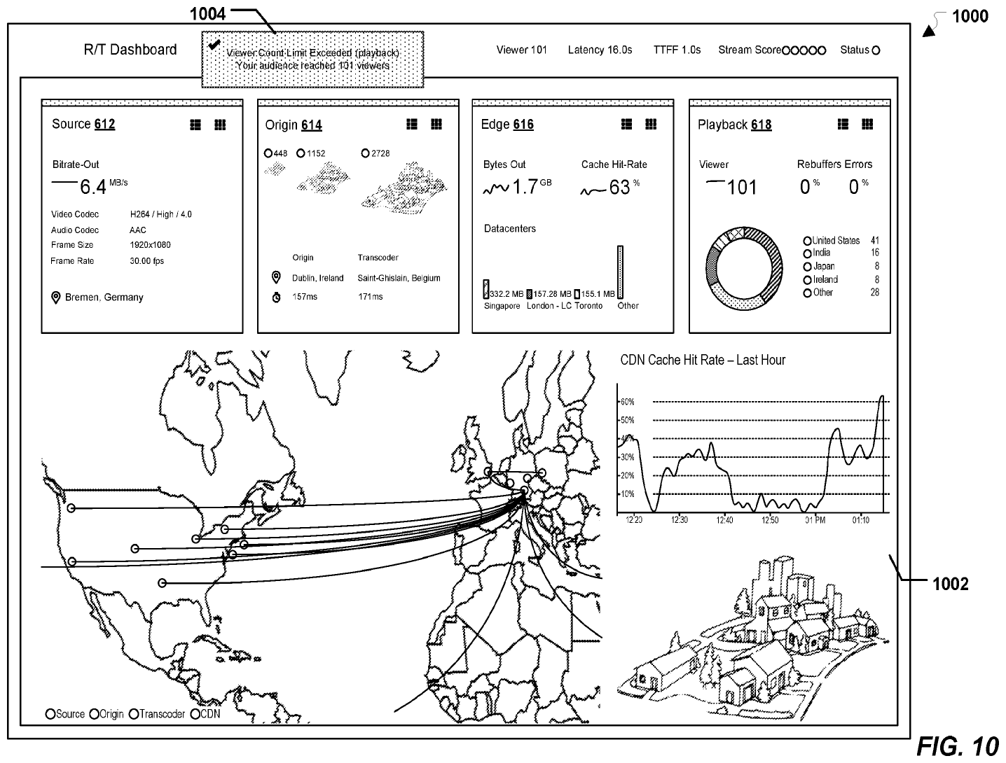

Referring to FIG. 10, an example of a GUI is shown and generally designated 1000. In a particular aspect, the GUI 1000 is generated by the analytics engine 160, the system 100 of FIG. 1, the test analyzer 360, the system 300 of FIG. 3, the live stream analyzer 464, the system 400 of FIG. 4, the post-broadcast analyzer 566, the system 500 of FIG. 5, or a combination thereof. In a particular aspect, the GUI 1000 corresponds to the GUI 105 of FIG. 1.

The GUI 1000 includes an alert 1004 indicating that a particular network condition (e.g., a viewer count has exceeded a threshold) has been detected. The GUI 1000 includes a display element 1002 that includes a map illustrating streaming of the live stream 103 via network nodes in various geographic locations. The GUI 1000 thus enables a user to determine how the streaming is progressing across geographic regions.

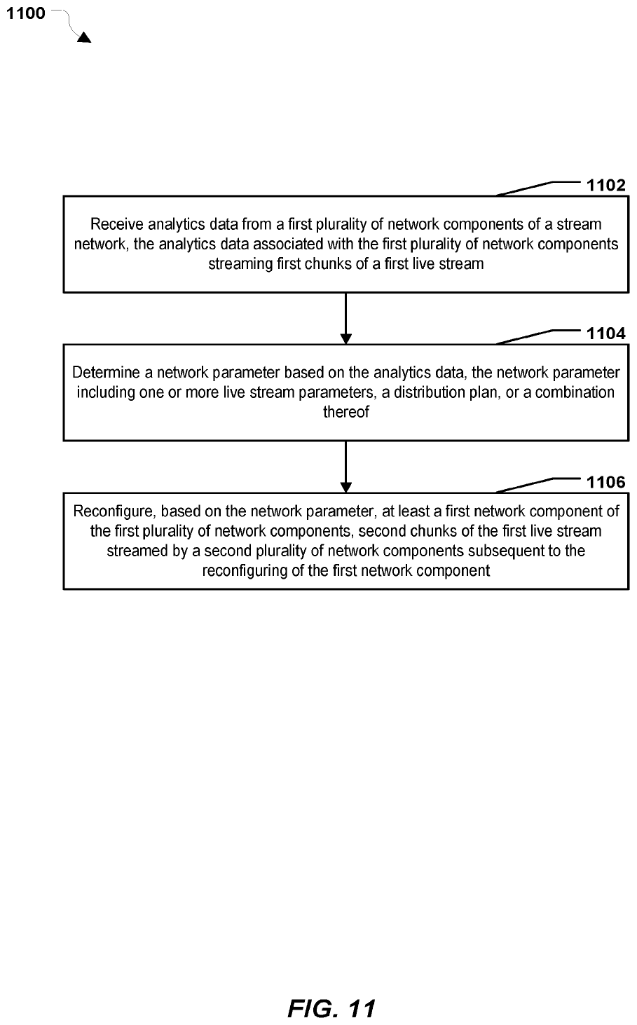

In FIG. 11, a method of performing live stream analytics is shown and generally designated 1100. In a particular aspect, one or more operations of the method 1100 are performed by one or more components of the analytics engine 160, the processors 168, the control engine 170, the user device 106, the stream network 102, the system 100 of FIG. 1, the live stream analyzer 464, the system 400 of FIG. 4, or a combination thereof.

The method 1100 includes receiving analytics data from a first plurality of network components of a stream network, at 1102. For example, the analytics engine 160 of FIG. 1 receives the analytics data 419 from network components of the network paths 348, the live stream audience 362, or a combination thereof, as described with reference to FIG. 4. The analytics data 419 is associated with the network components (e.g., of the network paths 348, the live stream audience 362, or a combination thereof) streaming first chunks of the live stream 325, as described with reference to FIG. 4.

The method 1100 also includes determining a network parameter based on the analytics data, at 1104. For example, the live stream analyzer 464 determines a network parameter (e.g., the live stream parameters 421, the distribution plan 443, or a combination thereof) based on the analytics data 419, as described with reference to FIG. 4.

The method 1100 further includes reconfiguring, based on the network parameter, at least a first network component of the first plurality of network components, at 1106. For example, the control engine 170 of FIG. 1 reconfigures, based on the network parameter (e.g., the live stream parameters 421, the distribution plan 443, or a combination thereof), at least a network component of the network paths 348, the live stream audience 362, the network paths 448, or a combination thereof. Second chunks of the live stream 325 are streamed by network components of the network paths 448, the live stream audience 362, or a combination thereof, subsequent to the reconfiguring of the network component, as described with reference to FIG. 4.

The method 1100 thus enables reconfiguring of the stream network 102 during streaming of the live stream 325. Reconfiguring the stream network 102 can address certain issues detected during streaming of the live stream 325. It will be appreciated that the method 1100 (or a variation thereof) can also be used to determine, after one stream has concluded, how to communicate another stream to increase that other stream's likelihood of success.

It should be noted that the orders of operations illustrated in the flowchart of FIG. 11 and described elsewhere herein are to be considered illustrative, and not limiting. In alternate implementations, the order of operations may be different. Further, one or more operations may be optional and/or replaced by other operations. In addition, one or more operations may be consolidated and, in some cases, may be performed at least partially concurrently.

It should be noted that although the foregoing implementations are described with reference to a live stream being captured by a media device, in alternate implementations, the described techniques may also be used in conjunction with media data stored at the media device (e.g., a video on demand (VOD) stream).

In accordance with various implementations of the present disclosure, one or more methods, functions, and modules described herein may be implemented by software programs executable by a computer system Further, implementations can include distributed processing, component/object distributed processing, and/or parallel processing.

Particular implementations can be implemented using a computer system executing a set of instructions that cause the computer system to perform any one or more of the methods or computer-based functions disclosed herein. A computer system may include a laptop computer, a desktop computer, a server computer, a mobile phone, a tablet computer, a set-top box, a media player, a hardware encoder one or more other computing devices, or any combination thereof. The computer system may be connected, e.g., using a network, to other computer systems or peripheral devices. For example, the computer system or components thereof can include or be included within one or more components of the user device 106, the user device 108, the analytics engine 160, the control engine 170, stream network 102 of FIG. 1, or a combination thereof.

In a networked deployment, the computer system may operate in the capacity of a server or as a client user computer in a server-client user network environment, or as a peer computer system in a peer-to-peer (or distributed) network environment. The term “system” can include any collection of systems or sub-systems that individually or jointly execute a set, or multiple sets, of instructions to perform one or more computer functions.

In a particular implementation, the instructions can be embodied in a computer-readable or a processor-readable device, such as the data storage devices 110. The terms “computer-readable device” and “processor-readable device” include a single storage device or multiple storage devices, such as a centralized or distributed database, and/or associated caches and servers that store one or more sets of instructions. The terms “computer-readable device” and “processor-readable device” also include any device that is capable of storing a set of instructions for execution by a processor or that cause a computer system to perform any one or more of the methods or operations disclosed herein. For example, a computer-readable or processor-readable device or storage device may include random access memory (RAM), flash memory, read-only memory (ROM), programmable read-only memory (PROM), erasable programmable read-only memory (EPROM), electrically erasable programmable read-only memory (EEPROM), registers, a hard disk, a removable disk, a disc-based memory (e.g., compact disc read-only memory (CD-ROM)), a solid-state memory, or any other form of storage device. A computer-readable or processor-readable device is not a signal.

As used herein, a “live” stream may differ from a “video on demand” (VOD) stream. A VOD stream originates from, or corresponds to, content that is available in its entirety at a stream source when a packet of the VOD stream is sent. For example, a VOD stream may correspond to a movie or television show that is stored at a storage device. A live stream corresponds to content that is not available in its entirety when a packet of the live stream is sent. For example, a live stream may be used to transmit audio and/or video content corresponding to an event as the event is being captured (e.g., in real-time or near-real time). Examples of such events may include, but are not limited to, in-progress sporting events, musical performances, video-conferences, webcam feeds, birthday parties, school plays, and other streams captured by fixed or mobile devices. It should be noted that a live stream may be delayed with respect to the event being captured (e.g., in accordance with government or industry regulations, such as delay regulations enforced by the Federal Communications Commission (FCC)). A DVR stream corresponds to a time-shifted version of a live stream that is generated by a device that receives the live stream, where the device may still be receiving live stream or may have finished receiving the live stream Thus, network DVR content may be generated by a device that receives a stream via a network and “records” the received stream, such as for subsequent transmission via a network to another device. The described systems and methods may be used in conjunction with “live linear television (TV)” streams, which may include a live feed, or a VOD asset or a DVR asset being rebroadcast as a live feed. It should also be noted that although certain embodiments may be described herein with reference to video streams, video on demand content, digital video recorder content, etc., not all of the described techniques may require video content/data. Certain embodiments may also be used with content that does not include video (e.g., audio on demand, radio content, music streams, etc.).

In a particular aspect, a method includes receiving analytics data from a first plurality of network components of a stream network. The analytics data is associated with the first plurality of network components streaming first chunks of a first live stream The method also includes determining a network parameter based on the analytics data. The network parameter includes one or more live stream parameters, a distribution plan, or a combination thereof. The method further includes reconfiguring, based on the network parameter, at least a first network component of the first plurality of network components. Second chunks of the first live stream are streamed by a second plurality of network components subsequent to the reconfiguring of the first network component.

In a particular aspect, an apparatus includes a memory and a processor coupled to the memory. The processor is configured to perform, control, or initiate operations including receiving analytics data from a first plurality of network components of a stream network. The analytics data is associated with the first plurality of network components used to stream a first live stream The operations also include determining a network parameter based on the analytics data. The network parameter includes one or more live stream parameters, a distribution plan, or a combination thereof. The operations further include reconfiguring, based on the network parameter, at least a first network component of the first plurality of network components. A second live stream is streamed by a second plurality of network components subsequent to the reconfiguring of the first network component.

In a particular aspect, a computer-readable storage device stores instructions that, when executed by a processor, cause the processor to perform operations including receiving analytics data from a first plurality of network components of a stream network. The analytics data is associated with the first plurality of network components used to stream a first live stream The operations also include generating a graphical user interface (GUI) based on the analytics data. The GUI includes a display element to display content of the first live stream The GUI further displays a portion of the analytics data corresponding to a portion of the content on display by the display element. The operations further include providing the GUI to a display device.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific implementations have been illustrated and described herein, it should be appreciated that any subsequent arrangement designed to achieve the same or similar purpose may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving analytics data from a first plurality of network components of a stream network, the analytics data associated with the first plurality of network components streaming first chunks of a first live stream;
determining a network parameter based on the analytics data, the network parameter including one or more live stream parameters, a distribution plan, or a combination thereof; and
reconfiguring, based on the network parameter, at least a first network component of the first plurality of network components, second chunks of the first live stream streamed by a second plurality of network components subsequent to the reconfiguring of the first network component.

2. The method of claim 1, wherein the one or more live stream parameters include a transcoder profile associated with the first live stream.

3. The method of claim 1, wherein the one or more live stream parameters include a bit rate associated with the first live stream.

4. The method of claim 1, wherein the one or more live stream parameters include a frame rate associated with the first live stream.

5. The method of claim 1, wherein the one or more live stream parameters include a frame size associated with the first live stream.

6. The method of claim 1, further comprising storing the one or more live stream parameters in a profile associated with a user.

7. The method of claim 1, wherein the analytics data includes quality of service (QOS) data generated by a player device of the first plurality of network components.

8. The method of claim 1, wherein the analytics data includes streaming performance data generated by a content delivery network (CDN) device of the first plurality of network components, and wherein the streaming performance data indicates a cache hit rate, a count of renditions served, a count of datacenters used, a count of bytes served, a count of viewers served, or a combination thereof.

9. The method of claim 1, wherein the analytics data includes streaming performance data generated by a transcoder of the first plurality of network components, and wherein the streaming performance data indicates a transcoding protocol, a transcoding time, or both.

10. The method of claim 1, wherein the analytics data includes streaming performance data generated by an encoder of the first plurality of network components, and wherein the streaming performance data indicates an encoding protocol, an encoding time, or both.

11. An apparatus comprising:
a memory; and
a processor coupled to the memory, the processor configured to perform, control, or initiate operations comprising:
receiving analytics data from a first plurality of network components of a stream network, the analytics data associated with the first plurality of network components used to stream a first live stream;
determining a network parameter based on the analytics data, the network parameter including one or more live stream parameters, a distribution plan, or a combination thereof; and
reconfiguring, based on the network parameter, at least a first network component of the first plurality of network components, a second live stream streamed by a second plurality of network components subsequent to the reconfiguring of the first network component.

12. The apparatus of claim 11, wherein at least one player device of the second plurality of network components is not included in the first plurality of network components.

13. The apparatus of claim 11, wherein at least one player device of the first plurality of network components includes a virtual player device.

14. The apparatus of claim 11, wherein the one or more live stream parameters include a transcoder profile associated with the second live stream.

15. The apparatus of claim 11, wherein the one or more live stream parameters include a bit rate associated with the second live stream.

16. The apparatus of claim 11, wherein the analytics data includes quality of service (QOS) data generated by a player device of the first plurality of network components.

17. The apparatus of claim 11, wherein the analytics data includes streaming performance data generated by a content delivery network (CDN) device of the first plurality of network components, and wherein the streaming performance data indicates a cache hit rate, a count of renditions served, a count of datacenters used, a count of bytes served, a count of viewers served, or a combination thereof.

18. A computer-readable storage device storing instructions that, when executed by a processor, cause the processor to perform operations comprising:
receiving analytics data from a first plurality of network components of a stream network, the analytics data associated with the first plurality of network components used to stream a first live stream;
generating a graphical user interface (GUI) based on the analytics data, the GUI including a display element to display content of the first live stream, wherein the GUI further displays a portion of the analytics data corresponding to a portion of the content on display by the display element; and
providing the GUI to a display device.

19. The computer-readable storage device of claim 18, wherein the GUI is generated subsequent to an end of streaming of the first live stream.

20. The computer-readable storage device of claim 18, wherein the GUI is generated during streaming of the first live stream.
